(19) United States
(12) Patent Application Publication
(10) Pub. No.: US 2023/0089649 A1
(43) Pub. Date: Mar. 23, 2023

(54) Method for Identifying Gum Line of Tooth Model, Device, and Storage Medium

(71) Applicant: GUANGZHOU HEYGEARS IMC.INC, Guangzhou (CN)

(72) Inventors: Yong WANG, Guangzhou (CN); Wei FENG, Guangzhou (CN)

(21) Appl. No.: 18/072,732

(22) Filed: Dec. 1, 2022

Related U.S. Application Data
(63) Continuation-in-part of application No. PCT/CN2020/134573, filed on Dec. 8, 2020.

(30) Foreign Application Priority Data
Jul. 2, 2020 (CN) 202010634000.2

(51) Int. Cl. A61C 7/00

(52) U.S. Cl. CPC A61C 7/002; A61C 2007/004

(57) ABSTRACT

A method and system for identifying a gum line of a tooth model, a device, and a storage medium are disclosed. The method includes:extracting a plurality of feature points from the tooth model based on a curvature algorithm, pre-processing each of the feature points, and outputting a contour point group (S1); obtaining a target reference line from a pre-stored reference line pool withthe target reference line being matched witha shape parameter of the tooth model (S2); fitting the target reference line based on the contour point group by iterative operation, to generate a fitting reference line (S3); and performing smoothing processing on the fitting reference line by using a dimensionality reduction algorithm, to output the gum line (S4).

### CROSS-REFERENCE TO RELATED DISCLOSURE

The present disclosure is proposed based on Chinese Patent Application No. 202010634000.2 and filed on 02 Jul. 2020, and claims priority to the Chinese Patent Application, the disclosure of which is hereby incorporated into the present disclosure for reference in its entirety.

### TECHNICAL FIELD

The present disclosure relates to the technical field of orthodontics, and in particular, to a method for identifying a gum line of a tooth model, a device, and a storage medium.

### BACKGROUND

### Term Explanation

Invisible Orthodontic: refers to invisible orthodontics without brackets, and belongs to one type of orthodontics.

With the development of scientific and technical information, technologies such as computer technology, manufacturing technology, digital modeling technology, material science, numerical control technology, etc. have rapidly developed and grew stronger, and these subjects merge with each other. In particular, the computer technology has been increasingly infiltrated into various aspects such as teaching, scientific research and clinical applications in various medical fields, and can achieve more progressive mutual cooperation. Moreover, with the development and popularity of measurement technology, people can conveniently acquire digitized tooth models, which plays an important role in the process of oral clinical diagnosis and treatment. The emergence and development of 3D printing technology has become one of the current hot topics, and applying the 3D printing technology to the medical field is also very common. 3D printing has been applied in the medical field for more than two decades, and is widely applied to operations such as oral planting, orthopaedics, and neurosurgery.

Dental treatment is an unavoidable problem for most people. With the improvement of computer software and hardware technologies and the appearance of increasingly precise tooth data, people also turn their attention from traditional pure manual dental treatment to digitized dental treatment such as tooth diagnosis and treatment in the invisible orthodontic, so as to improve the safety and success rate of dental treatment with the help of priori knowledge provided by advanced digital technology.

In the current application scenarios of tooth diagnosis and treatment in the invisible orthodontic, performing data processing on tooth models are all needed; however, data pre-processing of the tooth models occupies most of the time of 3D printing of tooth model. In particular, in application scenarios of orthodontics, in addition to requiring to perform data pre-processing including placement, hollowing and Boolean operations on a tooth model, after printing is completed, it is also necessary to perform film pressing, and after the film pressing, manual cutting is required, or a gum line is manually drawn to supply to a CNC machine for cutting. This process needs to consume significant labor costs and significant workload. In order to increase the efficiency of the whole diagnosis and treatment process and enhance the user experience, it is necessary to shorten the data processing time of tooth model data.

In addition, currently, an automatic processing flow of orthodontics is still in a blank stage in China, and therefore there is an urgent need to achieve automatic generation and processing flow of orthodontics according to technologies such as artificial intelligence algorithm, 3D printing and numerical control machining, so as to improve the working efficiency and competitiveness of the whole industry.

Regarding the current domestic technical problems of low degree of automation, poor efficiency and poor user experience during data processing of tooth models in an orthodontic automatic process, the technical solutions of some embodiments of the present disclosure take efficiency improvement as a basis, innovatively explore a combination of the dental field and the 3D printing technology, and integrate the digital 3D printing technology into a dental restoration process. By introducing artificial intelligence technology and a series of algorithms to automatically identify data of a gum line, manpower is reduced, digital production is deepened, and the vacancy of technology of low degree of automation, poor efficiency and poor user experience during data processing of tooth models in an orthodontic process is filled up, laying a firm foundation for subsequent application scenarios of combining dentistry with 3D technology.

### Summary

In order to solve the described technical problems, the object of the present disclosure is to provide a method and system for identifying a gum line of a tooth model, a device, and a storage medium.

A first technical solution used in some embodiments of the present disclosure is:
a method for identifying a gum line of a tooth model, comprising the following steps:
a plurality of feature points are extracted from the tooth model based on a curvature algorithm, each of the feature pointsis pre-processed, and a contour point groupis output;
a target reference line is obtained from a pre-stored reference line pool,wherein the target reference line is matched with a shape parameter of the tooth model;
the target reference lineis fittedbased on the contour point group by iterative operation, to generate a fitting reference line; and
the fitting reference line is fitted based on the contour point group by iterative operation, to output the gum line.

A second technical solution used in some embodiments of the present disclosure is:

a device, including a memory and a processor, wherein the memory is used for storing at least one program, and the processor is used for loading the at least one program to execute the described method.

A third technical solution used in some embodiments of the present disclosure is:

a storage medium, in which a program executable by a processor is stored, wherein the program executable by the processor is used for executing the described method when executed by the processor.

### BRIEF DESCRIPTION OF THE DRAWINGS

FIG. 1 is a flowchart of steps of a method for identifying a gum line of a tooth model in some embodiments of the present disclosure;

FIG. 2 is a structural block diagram of a system for identifying a gum line of a tooth model in some embodiments of the present disclosure;

FIG. 3 is a schematic flow diagram of a method for identifying a gum line of a tooth model provided in some embodiments of the present disclosure.

### DETAILED DESCRIPTION OF THE EMBODIMENTS

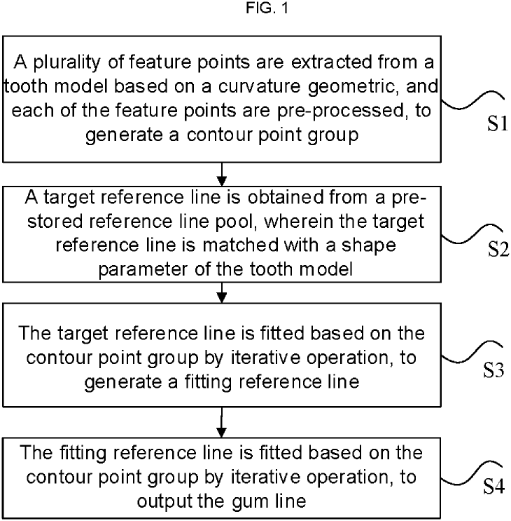

As shown in FIG. 1, the present embodiment provides a method for identifying a gum line of a tooth model, including the following steps:
S1, a plurality of feature points are extracted from a tooth model based on a geometric algorithm of curvature, and each of the feature pointsare pre-processed, to generate acontour point group;
S2, a target reference line is obtained from a pre-stored reference line pool, wherein the target reference line is matched with a shape parameter of the tooth model;
S3, the target reference line is fittedbased on the contour pointgroup by iterative operation, to generate a fitting reference line; and
S4, the fitting reference line is fitted based on the contour point group by iterative operation, to output the gum line.

In the present embodiment, the tooth model is a tooth model which is prepared by processing and repairing based on a 3D printing technology and a computer program and has a flat bottom surface. The geometric algorithm of curvatureis a method to calculate a rotation rate of a tangential direction angle of a surface on the tooth model to anarc length, which indicates the recessed or raised degree of the surface. A direction of the target reference line is the same as a direction of the contour point group (a direction of the tooth model,that is, a direction of an opening of the tooth model), so as to ensure that the range of the target reference line can cover a region of the contour point group. Specifically, after the shape parameter and a flat bottom surface of the imported tooth model are identified, the tooth model is adjusted to a target position; then the plurality of feature points are extracted from the tooth model at the target position according to the geometric algorithm of curvature; a reference line having the minimum deviation from a pre-stored reference line pool is obtained, as the target reference line, wherein the target reference line is matched with the identified shape parameter of the tooth model; the iterative operation on the target reference line is performed according to the contour point group, to generate the fitting reference line; and the smoothing processing on the fitting reference line is performed by using the dimensionality reduction algorithm, to finally output the gum line, so as to complete preprocessing of data of the tooth model. Regarding the problems of large workload, high labor costs, low working efficiency and poor user experience in data processing of a tooth model, such as in the current application scenarios of invisible orthodontic, the technical solutions of some embodiments of the present disclosure provide a method for identifying a gum line of a tooth model, which can greatly simplify an orthodontic automatic generation and processing flow, reduce the working costs, shorten the data processing time of tooth model data, improve the working efficiency, and enhance the user experience, and also establish application scenarios combining dental diagnosis and treatment with a 3D technology, and supplement the blank of domestic orthodontic automatic processing flow. In addition, the method for identifying a gum line of a tooth model provided in the present embodiment is also applicable to tooth models having arbitrary flat bottom surfaces and arbitrary directions, and the implementation of some embodiments of the present disclosure is not affected by the other tooth model types having arbitrary flat bottom surfaces.

As at least one alternative embodiment, the pre-processing in the step S1 includes filtering or denoising; the step S1 includes the following steps:
S11, the tooth model is acquired, the flat bottom surface and a shape parameter of the tooth modelare identified, and the tooth model is adjusted to a target positionbased on the shape parameters and the flat bottom surface;
S12, the plurality of feature points are extracted from the tooth model at a target position by using thegeometric algorithm of curvature, wherein the feature points are distributed in recessed and raised regions of the tooth model; and
S13, each of the feature points isperformed filtering processing or denoising processing, to generate a contour point group.

In the present embodiment, the initially obtained feature points of the tooth model are denoised or filtered, to eliminate the effect of feature points in non-gum line regions on the fitting process subsequently performed on contour lines; and the geometric algorithm of curvatureis a method to calculate a rotation rate of a tangential direction angle of a surface on the tooth model to aarc length, which indicates the recessed or raised degree of the surface, and saidrecessed or raised degree is referred to as feature in the solutions of some embodiments of the present disclosure, and the feature points can be extracted from recessed and raised regions of the tooth model by means of a curvature calculationmethod.

As at least one alternative embodiment, the step S11 includes the following steps:
S111, the tooth model is acquired, the flat bottom surface and the shape parameter of the tooth modelare identified, and a normal vector of the flat bottom surface is output;
S112, the tooth model is rotated to a target plane according to the normal vector of the flat bottom surface and a first objective normal vector;
S113, a contour of the tooth model on the target plane is acquired, a skeleton curvilinear equation of a tooth skeleton is determined according to the contour, and a direction vector of the tooth modelbased on the skeleton curvilinear equation is output; and
S114, the tooth model is rotated to the target position according tothe direction vector of the tooth model and a second objective normal vector.

In the present embodiment, the first objective normal vector is a corresponding normal vector of the tooth model when the tooth model is rotated to the target plane, that is, the normal vector of the target plane; and the second objective normal vector is a corresponding normal vector of the tooth model when the tooth model is rotated to the target position, that is, the normal vector corresponding to the target position. Specifically, first, an imported tooth model is acquired, and by acquiring a tooth model having a flat bottom surface in any direction, a normal vector of the bottom surface is acquired, and the tooth model is rotated to the target plane on based on a cross product method and the first objective normal vector; second, when the tooth model is located in the target plane, the tooth model is projected to obtain a contour line; skeleton extraction on the contour line is performed, and the extracted skeleton is performed noise processing, to acquire a smooth and continuous skeleton line; a skeleton curvilinear equation is solved, to obtain a direction vector of thetooth model, that is, the direction vector of the opening of the tooth model ; and based on the obtained direction vector of thetooth model and the second objective normal vector of the target position, a rotation angle and a rotation axis are worked out according to a cross product method, and then the tooth model is rotated to the target position, thereby a tooth model in any direction is automatically adjusted to the target position.

As at least one alternative embodiment, the shape parameter includes the shape of the tooth model, and the step S2 includes the following steps:
S21, a direction of the tooth model is determined according to the shape of the tooth model;
S22, initial reference lines with the same direction as the tooth model are obtained from the pre-stored reference line pool; and
S23, the target reference line is screened from the initial reference linesaccording to a pre-established coordinate system and a first threshold.

In the present embodiment, the coordinate system is a rectangular coordinate system with X, Y and Z axes, and other coordinate systems may also be selected according to application scenarios, which are not described herein again. The preset threshold refers to a value that achieves a minimum deviation between the obtained initial reference lines and the tooth model in the established coordinate system. Each initial reference line refers to a gum line file of tooth model, and the file is composed of point coordinates; and the fitting reference pool actually includes historical gum lines that have been subjected to smoothing processing, these gum lines being generated based on other tooth models.

As at least one alternative embodiment, the step S3 includes the following steps:
S31, a centroid of the target reference line and a centroid of the contour point group is performedgeometric superposition based onthe pre-established coordinate system; and
S32, the target reference line and each of the feature points of the contour point group are performed fitting by using an approximate iterative algorithm, to generate the fitting reference line.

In the present embodiment, the approximate iterative algorithm means that after the target reference line is projected, it iterates circularly until the projection error is less than asecond threshold;Specifically, the contour point group and the target reference line are acquired, the centroid of the target reference line and a centroid of a contour point group are geometrically superposed in the pre built coordinate system, and after the target reference line is circularly projected, the final projected points are connected to form the fitting reference line, so as to ensure that the fitting reference line can cover the region of the contour point group.

As at least one alternative embodiment, the dimensionality reduction algorithm uses a principal component analysis method, and the step S4 includes the following steps:
S41, the main contour shape of the initial fitting lineis obtained by using the principal component analysis method, to extract main direction points of the fitting reference line; and
S42, the main direction points are spline interpolated and smooth connection on to output the gum line.

In the present embodiment, the generated fitting reference line is not a smooth line, and may have situations of local folding and deviation. With regard to such situations, the principal component analysis (PCA) method is used to acquire a main contour shape of the fitting reference line to determine main direction points of the contour, and the main direction pointsof the fitting reference line are extracted based on the main contour shape, and the main direction points are connected smoothly after interpolation using interpolation splines such as a Kochanek-Bartels pattern, thereby avoiding unsmooth regions of line segments, and a final smooth gum line required is obtained.

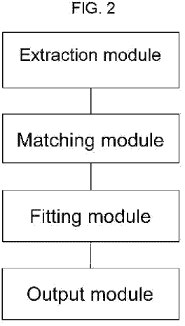

As shown in FIG. 2, the present embodiment provides a system for identifying a gum line of a tooth model, including:
an extraction module, configured to extract a plurality of feature points from the tooth model based on a geometric algorithm of curvature, pre-process each of the feature points, and output a contour point group;
a matching module, configured to obtain a target reference line from a pre-stored reference line pool, wherein the target reference line is matched witha shape parameter of the tooth model;
an fitting module, cond to fit the target reference line based on the contour point, to generate a fitting reference line; and
an output module, cond to perform smoothing processing on the fitting reference line by using a dimensionality reduction algorithm, to output the gum line.

As at least one alternative embodiment, the extraction module includes:
an identification unit, cond to identify the shape parameter and a flat bottom surface of the tooth model, and adjust the tooth model to a target positionbased on the shape parameters and the flat bottom surface;
an extraction unit, cond to extract the plurality of feature points from the tooth model at the target position by using thegeometric algorithm of curvature, wherein the plurality of feature points are distributed in recessed and raised regions of the tooth model; and
a generation unit, cond to perform filtering processing or denoising processing on the each of the feature points, and then generate the feature contour point group.

As at least one alternative embodiment, the identification unit includes:
an acquisition sub-unit, cond to acquire the tooth model, identify the flat bottom surface and the shape parameter of the tooth model, and output a normal vector of the flat bottom surface;
a first rotation sub-unit, cond to rotate the tooth model to a target plane according to the normal vector of the flat bottom surface and a first objective normal vector;
an output sub-unit, cond to acquire a contour of the tooth model on the target plane, determine a skeleton curvilinear equation of a tooth model according to the contour, and output a direction vector of the tooth modelbased on the skeleton curvilinear equation; and
a second rotation sub-unit, cond to rotate the tooth model to the target position according to the direction vector of the tooth model and a second objective normal vector.

As at least one alternative embodiment, the matching module includes:
a determination unit, cond to determine a direction of the tooth model according to the shape of the tooth model;
a matching unit, cond to match initial reference lines with the same direction of the tooth model from a pre-stored reference line pool, based on the direction of the tooth model; and
a screening unit, cond to screen the target reference line from the initial reference lines according to a pre-established coordinate system and a preset threshold.

As at least one alternative embodiment, the iteration module includes:
a superposition unit, cond to perform geometric superposition on the centroid of the target reference line and the centroid of the contour point group based on the pre-established coordinate system; and
an iteration unit, cond to perform fitting on the target reference line and each of the feature points of the contour point group by using an approximate iterative algorithm, to generate the fitting reference line.

As at least one alternative embodiment, the output module includes:
a smoothing unit, cond to perform smoothing processing on the fitting reference line by using the principal component analysis method, and extract main direction points of the fitting reference line; and
a connection unit, cond to perform spline interpolation and smooth connection on the main direction pointsto output the gum line.

A device, including a memory and a processor, wherein the memory is used for storing at least one program, and the processor is used for loading the at least one program to execute the method according to the method embodiment.

The device of the present embodiment can execute the method for identifying a gum line of a tooth model provided by the method embodiment of the present disclosure, can execute any combined implementation steps of the method embodiment, and has the corresponding functions and beneficial effects of the method.

A storage medium, in which a program executable by a processor is stored, wherein the program executable by the processor is used for executing the method of the method embodiment when executed by the processor.

### Specific Embodiment

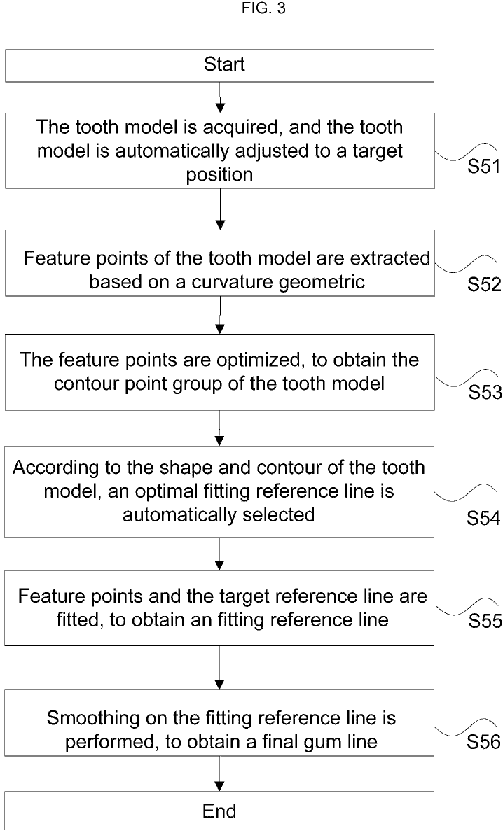

FIG. 3 is a schematic flow diagram of a method for identifying a gum line of a tooth model provided in some embodiments of the present disclosure. Said method includes the following steps: A tooth model is imported, and a rectangular coordinate system is established.

S51, The tooth model is acquired, and the tooth model is automatically adjusted to a target position.

As at least one alternative embodiment:
(1) The imported tooth model is a tooth model withflat bottom surface in any direction, wherein the tooth model is a digital three-dimensional body composed of a series of triangular patches.
(2) A maximum plane of the tooth model is detected. Wherein the method for detecting the maximum plane of the tooth model is: a certain triangular patch is set, the set triangular patch and the tooth model composed of triangular patches are superposed. An error threshold e is set, and when e is greater than a certain value, it is considered that the set triangular patch is not flush with the patches on the tooth model; otherwise, it is considered that they are located on the same plane. When the set triangular patch is on the same plane as a certain patch of the tooth model, the two are superposed together, and a next triangular patch is continuously searched and an error threshold is determined. The described steps are repeated until the maximum plane of the tooth model is obtained. During the detection of the maximum plane of the tooth model, an equation of the plane thereof can be obtained.Or, each triangular patch of the tooth model is traversed, the triangular patches with the same normal vector are stacked, the area ofthe triangular patches corresponding to different normal vectors and the stacked plane are compared, and the triangular patch or the stacked plane with the largest area as the flat bottom is determined.
(3) According to a cross product operation method, a first rotation angle and a first rotation axis are solved according to vector values before and after afirst rotation, wherein the cross product operation method is a binary operation of vectors in a vector space, and an operation result thereof is a vector rather than a scalar; and an arbitrary model can be rotated to a desired spatial position according to the first rotation angle and the first rotation axis. It should be noted that, the purpose of the first rotation is to adjust the tooth model based on the direction vector of the flat bottom surface of the tooth model, so that the flat bottom surface of the tooth model is placed on the target plane.
(4) The tooth model is acquired based on the first rotation achieved in (3), and then the tooth model is projected into a tooth contour line, wherein the tooth contour line is a contour of object obtained by projecting an object in a 3D space onto a 2D plane. The contour line of the tooth model is obtained, and can be represented by a quadratic curvilinear equation. A direction vector before the second rotation of the tooth model can be obtained by solving the curvilinear equation corresponding to the contour line; and according to the cross product operation method as in (3), a second rotation angle and a secondrotation axis are solved according to vector values before and after a secondrotation, and the tooth model is rotated to a desired target position based on a target plane according to the second rotation angle and the second rotation axis thereof.lt should be noted that the second rotation is to adjust the tooth model on the target plane based on the opening direction of the tooth model.

S52, Feature points of the tooth model are extracted based on a geometric algorithm of curvature.

Specifically: after the toothmodel is placed to thetarget position, the extracted feature points of the tooth model are filtered and de-noised according to thegeometric algorithm of curvature, so as to obtain a feature contour of the tooth model. The geometric algorithm of curvatureis a method to calculate a rotation rate of a tangential direction angle of a certain surface on a tooth model with respect to a corresponding arc length, which indicates the recessed or raised degree of the surface, and said degree is also referred to as feature in the present solution.That is, the feature points of recessed and raised regions of the tooth model can be acquired by the geometric algorithm of curvature (the true gum line on a tooth model is also reflected by recessed and raised regions).

S53, The feature points are optimized, to obtain the contour point group of the tooth model.

Specifically: for feature points of the tooth model obtained in Step S52, it is necessary to remove the noise. In addition tothe gum line region, other parts of teeth also have recessed or raised regions which are also mistaken as features, which will affect subsequent fitting with contour lines; thereforeneed to be filtered or removed, so as to finally obtain optimal feature points; wherein the contour point group includes a plurality of feature points remaining after optimization, and the distribution shape of the feature points in the contour point group (or contour point group shape for short) is similar to the gum line contour of the tooth model. It should be noted that the centroid of the contour point group may be understood as the centroid of the contour point group shape.

S54, According to the shape and contour of the tooth model, an optimal fitting reference line is automatically selected.

Specifically: the optimal fitting reference line is automatically selected according to the shape and contour of the tooth model after being imported and straightened, wherein the fitting reference line refers tothegum line file of tooth model, and the file is composed of point coordinates The main method for searching for the optimal fitting reference line is: first, a batch of initial reference lines in the same direction are matched according to the direction of the tooth model; and second, a initial reference line with the minimum deviation, i.e. the optimal target reference line is selected from the screened same-direction initial reference lines, according to the matching degree between the fitting reference lines and the tooth model determined based on three directions X, Y and Z..

S55, Feature points and the target reference line are fitted, to obtain a fitting reference line.

After obtaining the contour point group and target reference line, the target reference line needs to be overlapped or drawn as close as possible to the feature points in the contour point group.

Specifically: (1) After obtaining the contour point group and the target reference line, and the target reference line needs to be overlapped with or drawn close to the feature points of contour point group as far as possible, i.e. the centroid of the target reference line is translated in three directions, i.e. X, Y and Z, to coincide with the centroid of the tooth model; the centroid of the target reference line can made to coincide with the centroid of the contour point group shape, and also it is ensured that the target reference line can cover the region of the feature points in the contour point group. (2) An approximate iterative algorithm is used to fit the target reference line and the feature points of the contour point group, to form a fitting reference line. The fitting is to project points of the target reference line (substantially include a series of coordinate points) to the feature points closest thereto; and the approximate iteration means that after the target reference line is projected, iteration is continued until the projection error is less than a set threshold. (3) After the iteration is completed, the final projected points are connected to form a fitting reference line.

S56, Smoothing on the fitting reference line is performed, to obtain a final gum line.

Specifically: the fitting reference line is not a smooth line, and may have situations of local folding and deviation. With regard to such situations, in the present solution, a principal component analysis method is used to acquire a main contour shape of the fitting reference line, main direction points of the contour are determined, and the main direction points are smoothly connected by using a Kochanek-Bartels pattern, therebyunsmooth regions of line segments are avoided, and the final smooth gum line required is obtained.

Ending, the final gum line of the tooth model is output.

The present embodiment provides a method for producting of tooth instruments, including the following steps: The gum line of the tooth model is identified by the method of identifying a gum line of a tooth model described above. A cutting line based on the gum line is generated, and the cutting line into a data file recognizable is converted by a numerical control cutting machine.The membrane is pressed on the tooth modelto obtain a shell membrane.The shell membrane is cut based on the cutting line to obtain a shell shaped dental instrument.

In the present embodiment, a post-processing of the gum line can be carried out according to different application needs in the production of tooth instruments, for example, it mainly includes automatic acute angle removal and overall offset of gum line, andthe post-processing gum line is the cutting line.Specifically, after the gum line is generated, thegeneratedgum line is closely fitted with a real gum line of teeth. Since the intersection between two adjacent teeth is sharp, which does not meet the production process requirements of tooth instruments,thegenerated gum line needs to be smoothed, that is, the generatedgum line is removed the acute angle of the gum line, and a certain margin should be left between the gum line and the tooth, the gum line generated needs to offset as a whole downward (or upward), that is, the gum line is offset.Optionally, the angle of acute angle is limited to less than 180 °, and the overall offset is between 0 and 2 mm. Further,after the cutting line is obtained,the cutting lineis converted into the data (which can be called NC file) recognizable by the CNC cutting machine through a cutter path algorithm (NC program), and the data is performed simulation verification. For the data that fails to pass, the data of the gum line is readjusted, and the NC file is circularly generated until the verification is passed; Finally, NC cutting files that meet the requirements are output. The cutter path algorithm determines the final output NC file based on the machine parameters (such as rotation axis, coordinate positioning, speed, etc.)

The content above makes specific explanation on the preferred embodiments of the present disclosure, but the present innovative creation is not limited thereto. A person skilled in the art could also make various equivalent modifications or replacements without departing from the spirit of the present disclosure, and these equivalent modifications or replacements are all included in the scope defined by the claims of the present disclosure.

What is claimed is:

1. A method for identifying a gum line of a tooth model, comprising:
extracting a plurality of feature points from the tooth model based on a curvature algorithm, pre-processing each of the feature points, and outputting a contour point group;
obtaining a target reference line from a pre-stored reference line pool withthe target reference line being matched with a shape parameter of the tooth model;
fitting the target reference line based on the contour point group by iterative operation, to generate a fitting reference line; and
performing smoothing processing on the fitting reference line by using a dimensionality reduction algorithm, to output the gum line.

2. The method as claimed in claim 1, wherein the pre-processing comprises filtering processing or denoising processing; and the step of extracting a plurality of feature points from the tooth model based on a curvaturealgorithm, pre-processing each of the feature points, and outputting a contour point group comprises:
identifying the shape parameter and a flat bottom surface of the tooth model, and adjusting the tooth model to a target positionbased on the shape parameter and the flat bottom surface;
extracting the plurality of feature points from the tooth model at the target position by using the curvature algorithm, wherein the plurality of feature points are distributed in recessed and raised regions of the tooth model; and
performing filtering processing or denoising processing on the each of the feature points, to generatethe contour point group.

3. The method as claimed in claim 2, wherein the step of identifying the shape parameter and a flat bottom surface of the tooth model, adjusting the tooth model to a target position based on the shape parameters and the flat bottom surface comprises:
acquiring the tooth model, identifying the flat bottom surface and the shape parameter of the tooth model, and outputting a normal vector of the flat bottom surface;
rotating the tooth model to a target plane according to the normal vector of the flat bottom surface and a first objective normal vector;
acquiring a contour of the tooth model on the target plane, determining a skeleton curvilinear equation of a tooth model according to the contour, and outputting a direction vector of the tooth modelbased on the skeleton curvilinear equation; and
rotating the tooth model to the target position according to the direction vector of the tooth model and a second objective normal vector.

4. The method as claimed in claim 3, whereinthe first objective normal vector is a normal vector of the target plane, and the second objective normal vector is a normal vector of the target position.

5. The method as claimed in claim 3, wherein the step of acquiring a contour of the tooth model on the target plane, determining a skeleton curvilinear equation of a tooth model according to the contour comprises:
projecting the tooth model on the target plane to obtain the contourof the tooth model;
extractinga skeleton from the contour, and denoising the extracted skeleton to obtain the skeleton line, and determining the skeleton curvilinear equation based on the skeleton line.

6. The method as claimed in claim 2, wherein the step of adjusting the tooth model to a target position based on the shape parameter and the flat bottom surface comprises:
obtaining a first rotation angle and a first rotation axis according to vector values before and after a first rotation;
rotating the tooth model to a target plane according to the first rotation angle and the first rotation axis;
obtaining a second rotation angle and a second rotation axis according to vector values before and after a second rotation;
rotating the tooth model to the target position according to the second rotation angle and the second rotation axis.

7. The method as claimed in claim 2, wherein the step of identifying a flat bottom surface of the tooth model comprises:
traversing each triangular patch of the tooth model and stacking the triangular patches with the same normal vector;
comparing areas of the triangular patches corresponding to different normal vectors or the stacked plane to determine the flat bottom surface of the tooth model;
wherein the flat bottom surface is the triangular patch or the stacked plane with the largest area.

8. The method as claimed in claim 1, wherein the shape parameter comprises a shape, and the step of obtaining a target reference line from a pre-stored reference line pool withthe target reference line being matched with a shape parameter of the tooth modelcomprises:
determining a direction of the tooth model according to the shape of the tooth model;
obtaining initial reference lines from a pre-stored reference line poolwith the initial reference lines having the same direction as thetooth model; and
screening the target reference line from the initial reference lines according to apre-established coordinate system and a preset threshold.

9. The method as claimed in claim 8, wherein the step of screening the target reference line from the initial reference lines according to apre-established coordinate system and a first threshold comprises:
screening a reference linewith the minimum deviation from the tooth model in the coordinate system from the initial reference lines, to obtain thetarget reference line, wherein the first threshold is the value representing the minimum deviation between the matched initial reference lines and the tooth model.

10. The method as claimed in claim 1, wherein the step of fitting the target reference line based on the contour point group by iterative operation, to generate a fitting reference line comprises:
performing geometric superposition on a centroid of the target reference line and a centroid of the contour point group based on the pre-established coordinate system; and
fitting the target reference line and each of the feature points of the contour point group by using an approximate iterative algorithm, to generate the fitting reference line.

11. The method as claimed in claim 10, wherein the step of fitting the target reference line and each of the feature points of the contour point group by using an approximate iterative algorithm, to generate the fitting reference line comprises:
projecting the target reference line circularly until a projection error is less than a second threshold;
connecting projected points finally obtained to form the fitting reference line such that the fitting reference line covers a region of the contour point group.

12. The method as claimed in claim 1, wherein the dimensionality reduction algorithm comprises a principal component analysis method, and the step of performing smoothing processing on the fitting reference line by using a dimensionality reduction algorithm, to output the gum line comprises:
performing smoothing processing on the fitting reference line by using the principal component analysis method, to extract main direction points of the fitting reference line; and
performing spline interpolation and smooth connectiononthe main direction points to output the gum line.

13. The method as claimed in claim 12, wherein the step of performing spline interpolation on the main direction points comprises:
performing spline interpolation on the main direction points based on a Kochanek-Bartels pattern.

14. The method as claimed in claim 1 wherein the curvature algorithm is a method to calculatea rotation rate of the tangential direction angle of a surface on the dental mold to a arc length, and the each of the feature points is characterized by a corresponding rotation rate.

15. The method as claimed in claim 1, wherein the tooth model is a 3D tooth model withflat bottom surface in any direction, and the 3D tooth model is a digital three-dimensional body composed of a series of triangular patches.

16. The method as claimed in claim 1, wherein a direction of the target reference line is the same as a direction of the contour point group such that the target reference line covers a region of the contour point group;
the direction of the contour point group is a direction of an opening of the tooth model.

17. The method as claimed in claim 1, further comprising:
performing the acute angle removal operation on the gum line.

18. The method as claimed in claim 1, further comprising:
performing an offset operation on the gum line.

19. A device, comprising a memory and a processor, wherein the memory is cond to store at least one program, and the processor is cond to load the at least one program to execute the method of identifying a gum line of a tooth model,the methodcomprising:
extracting a plurality of feature points of tooth model based on curvature algorithm;
obtaining an initial reference line from a reference line pool according to a shape parameter of the tooth model;
fitting the initial reference line based on the plurality of feature points to output the gum line.

20. A non-transitorystorage medium, in which a program executable by a processor is stored, wherein the program executable by the processor is used for executing the method of identifying a gum line of a tooth model,the methodcomprising:
extracting a plurality of feature points of the tooth model, and outputting a contour point group based on the plurality of feature points, wherein the plurality of feature points are distributed in recessed and raised regions of the tooth model;
obtaining a initial reference line from a reference line pool according to a shape parameter of the tooth model;
performing geometric superposition on a centroid of the initial reference line and a centroid of the contour point group based on a pre-established coordinate system;
fitting the initial fitting reference line with the feature contour point group to output a gum line.
